(19) United States
(12) Patent Application Publication
(10) Pub. No.: US 2026/0029377 A1
(43) Pub. Date: Jan. 29, 2026

(54) METHOD OF CONTROLLING SENSITIVITY AND DYNAMIC RANGE OF A SENSOR

(71) Applicant: APOHA LIMITED, LONDON (GB)

(72) Inventor: SHAMIT SHRIVASTAVA, LONDON (GB)

(73) Assignee: APOHA LIMITED, LONDON, EN (GB)

(21) Appl. No.: 18/994,757

(22) PCT Filed: Jul. 20, 2023
(86) PCT No.: PCT/GB2023/051924

§ 371 Date: Jan. 15, 2025

(30) Foreign Application Priority Data
Jul. 20, 2022 (GB) 2210629.8

(51) Int. Cl. G01N 29/02; G01N 29/024; G01N 29/24

(52) U.S. Cl. CPC G01N 29/022; G01N 29/024; G01N 29/2418; G01N 2291/011; G01N 2291/022

(57) ABSTRACT

The present invention is directed to an analytical method, using surface waves excited in a liquid system forming part of a sensor, to determine a property of a test substance. An aspect of the disclosure provides a method for controlling a sensor for determining a property of a test substance, the sensor having a sensitivity and dynamic range, the sensor comprising: a liquid system comprising: a bulk liquid phase carrying a thin film on the surface of the bulk liquid phase: wherein the thin film comprises a film material and wherein the thin film exhibits an electrical response to mechanical stress and vice versa wherein said response depends on the thermodynamic state of the liquid system, the sensor configured to: contact the surface of the liquid system with the test substance thereby to generate a surface wave on the liquid system: and, determine the property of the test substance based on parameters of the surface wave: wherein the method for controlling the sensor comprises: controlling the sensitivity by changing a thermodynamic parameter of the liquid system.

### FIELD OF INVENTION

The present invention is directed to an analytical method, using surface waves excited in a liquid system forming part of a sensor, to determine a property of a test substance. The present invention further provides a method of adjusting at least one of the sensitivity and the dynamic range of the sensor.

### BACKGROUND

The surface of a material has a thermodynamic potential that is independent of its volume. The physical and chemical properties of a surface are derived from its thermodynamic potential. For example, the response of the surface to a mechanical perturbation is given by properties such as surface tension and lateral compressibility. Similarly, the response of the surface to an electromagnetic perturbation is given by properties such as surface dipole moment. As a result of these perturbation, different types surface waves may be generated on a surface e.g. a surface of a fluid (e.g. a liquid) forming an interface with another fluid (e.g. air). Some example types of surface waves are: Rayleigh waves; Gravity waves; Capillary waves; Lucassen waves. The physics of these waves have been described in Nonlinear fractional waves at elastic interfaces Julian Kappler, Shamit Shrivastava, Matthias F. Schneider, and Roland R. Netz Phys. Rev. Fluids 2, 114804—Published 20 Nov. 2017. These waves may be hydrodynamically coupled.

Rayleigh waves are characterised by elliptical motion of a notional fluid particle in a plane which is perpendicular to the surface at equilibrium and parallel to the direction of propagation of the wave.

Gravity waves are characterised by a displacement from equilibrium of a notional fluid particle at the surface wherein the displacement of the notional particle is characterised by having a restoring force of gravity or buoyancy.

Capillary waves are characterised by a displacement from equilibrium of a notional fluid particle wherein the displacement of the notional fluid particle is in a direction transverse to the surface at equilibrium and transverse to the direction of propagation of the wave and have a restoring force of surface tension.

Lucassen waves are characterised by a displacement from equilibrium of a notional fluid particle at a surface of a wave-medium by oscillation in a direction parallel to that surface at equilibrium and parallel to the direction of propagation of the wave. In Lucassen waves this notional particle is subject to a restoring force resulting from the surface elastic modulus of the surface of the wave-medium. Put another way Lucassen waves are compression-rarefaction waves which occur in the plane of a boundary (an interface) between a wave-medium and an adjacent medium such as air.

Lucassen waves have been observed in lipid monolayers and in other types of liquid systems.

Shamit Shrivastava, Matthias F. Schneider Opto-Mechanical Coupling in Interfaces under Static and Propagative Conditions and Its Biological Implications describes how a wave can be generated in a lipid monolayer mechanically with a dipper and how parameters of the generated wave, such as the intensity of fluorescent particles therein and the lateral pressure of the surface wave, can be measured, for example using a photo detector and a Wilhemly balance respectively.

Shrivastava S, Schneider M F. 2014 Evidence for two-dimensional solitary sound waves in a lipid controlled interface and its implications for biological signalling. J. R. Soc. Interface 11:20140098 describes a method in which Lucassen waves can be generated in a lipid monolayer and how parameters of said waves may be measured (e.g. fluorescence energy transfer (FRET) measurements; a piezo cantilever). The document also describes how the state of a lipid monolayer may be characterised by a variety of thin film parameters (e.g. surface density of lipid molecules, temperature, pH, lipid-type, ion or protein adsorption, solvent incorporation, etc.) and also how the state of the lipid monolayer can affect parameters of waves which propagate in the lipid monolayer.

Bernhard Fichtl, Shamit Shrivastava & Matthias F. Schneider, Protons at the speed of sound: Predicting specific biological signaling from physics Nature Scientific Reports describes how Lucassen waves can be generated in a lipid interface in response to a change in pH of the system and that the speed of these waves can be controlled by the compressibility of the interface. The document describes how parameters of these waves depend on the degree of change in pH. The document also describes how mechanical and electrical changes at the lipid interface can be measured (e.g. using a Kelvin probe).

Lucassen waves may be described as interfacial compression waves and may be considered two-dimensional sound waves (sound waves confined to a surface which forms a boundary between two phases e.g. a fluid-air boundary). In a manner analogous to sound waves, shock waves may exist in Lucassen wave systems (e.g. two-dimensional shock waves). Lucassen shock waves may be characterised in the same way as Lucassen waves with the additional constraint that the waves are characterised by changes in the wave medium which are nonlinear and/or discontinuous.

S. Shrivastava, Shock and detonation waves at an interface and the collision of action potentials, Progress in Biophysics and Molecular Biology, describes how Lucassen shock waves may propagate through a lipid interface.

WO2019234437A1 describes how a lipid interface may be used to transmit and receive signals. The document describes a signal processing device comprising: a first medium; a second medium; a lipid interface arranged between the first medium and the second medium, wherein the lipid interface comprises a plurality of lipid molecules; an input transducer arranged to apply an input signal to the lipid interface, wherein the input signal is arranged to generate a mechanical pulse in the lipid interface; and an output transducer arranged to receive an output signal by detecting a mechanical response in the lipid interface from the mechanical pulse generated in the lipid interface by the input transducer; wherein the lipid interface is arranged to propagate the mechanical pulse from the input transducer via the lipid interface to the output transducer.

### SUMMARY

Aspects of the invention are set out in the independent claims and optional features are set out in the dependent claims. Aspects of the disclosure may be provided in conjunction with each other, and features of one aspect may be applied to other aspects.

An aspect of the disclosure provides a method for controlling a sensor for determining a property of a test substance, the sensor having a sensitivity and dynamic range, the sensor comprising: a liquid system comprising: a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system, the sensor configured to: contact the surface of the liquid system with the test substance thereby to generate a surface wave on the liquid system; and, determine the property of the test substance based on parameters of the surface wave; wherein the method for controlling the sensor comprises: controlling the sensitivity by changing a thermodynamic parameter of the liquid system.

The film material may be a liquid, such as a liquid comprising protein or lipid.

A method is provided to adjust the sensitivity of the sensor. In adjusting the sensitivity, two difference analytes (e.g. test substances) each generating different characteristic signals can be identified using the same apparatus.

In examples, the method may comprise obtaining an indication of at least one thermodynamic parameter of the liquid system. The indication may be the change in intensity of light reflected from the lipid monolayer.

In examples, the method may comprise controlling the thermodynamic parameter of the liquid system based on the indication of the same thermodynamic parameter of the liquid system. The method may comprise controlling the lateral surface pressure based on indications (i.e. measurements) of changes in the lateral surface pressure. In such examples, changes in the lateral surface pressure may be measured directly using a Wilhelmy balance.

In examples, the method may comprise controlling the thermodynamic parameter of the liquid system based on the indication of another thermodynamic parameter of the liquid system. The method may comprise controlling the lateral surface pressure based on indications (i.e. measurements) of changes in the intensity of light reflected from the lipid monolayer. In such examples, the changes in intensity of light reflected from the lipid monolayer may be measured using an optical sensor.

A means of converting the measured changes in intensity of light reflected from the lipid monolayer to the corresponding changes in lateral surface pressure may be provided. For example, a processor of the optical sensor may be provided which may configured to perform said conversion.

In examples, the method may comprise controlling the sensitivity by changing a thermodynamic parameter of the liquid system comprises controlling the lateral surface pressure of the liquid system.

The sensitivity of the sensor may be proportional to the optomechanical susceptibility of the lipid monolayer. Controlling the lateral surface pressure of the lipid monolayer may control the optomechanical susceptibility of the lipid monolayer, which therefore controls the sensitivity of the sensor.

In general any two thermodynamic parameters of the liquid system may be used to obtain an indication of surface waves generated in the surface of the liquid system. For example, a surface wave may induce changes in a first thermodynamic parameter X of the liquid system, and a second thermodynamic parameter Y of the liquid system which is coupled to the first thermodynamic parameter X may be measured by a detector of the sensor. The strength of the coupling between the two thermodynamic parameters X and Y is given by the susceptibility. It will be readily understood by one skilled in the art that this general principle of controlling the sensor to comparatively increase or maximise a generic susceptibility

$${ψ}_{X - Y} ∝ \frac{δ X}{δ Y} .$$

In general the sensitivity of the sensor may be proportional to the susceptibility. In general the dynamic range of the sensor may be inversely proportional to the susceptibility.

In such examples, the generic susceptibility will depend on one or more thermodynamic parameters of the liquid system e.g. thermodynamic parameters X and Y or even a different thermodynamic parameter Z. Controlling the thermodynamic parameters upon which the generic susceptibility depends, then the sensitivity and dynamic range of the sensor can be controlled.

The thermodynamic parameter of the liquid system may comprise any of: the temperature of the liquid system; the concentration of the film material dispersed in the liquid system; the pH of the liquid system; the surface area of the thin film; the lateral surface pressure of the lipid thin film (π); the surface tension of the lipid thin film (γ); the surface concentration of the lipid thin film (Γ); the surface potential of the lipid thin film (ΔV); the surface elastic modulus of the lipid thin film (E); the capacitance of the thin film; the heat capacity of the thin film; an electromagnetic field applied to the liquid system; the conformation of the molecules of the thin film.

In examples, any thermodynamic parameter of the liquid system may be measured to infer the value of a coupled thermodynamic parameter. Two thermodynamic parameters are coupled if they are linked by a thermodynamic susceptibility. A thermodynamic susceptibility describes the change in a second thermodynamic parameter in response to a change in a first thermodynamic parameter. For example, change in the intensity of light reflected from the surface of the liquid system may be used to infer changes in the lateral surface pressure of the liquid system.

In examples, the method may comprise the lateral surface pressure of the liquid system is changed by changing the surface area of the liquid system. For example, a movable barrier of the state control means may be configured to change the surface area of the lipid monolayer.

An aspect of the disclosure provides a method for controlling a sensor for determining a property of a test substance, the sensor having a sensitivity and dynamic range, the sensor comprising: a liquid system comprising: a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system, the sensor configured to: contact the surface of the liquid system with the test substance thereby to generate a surface wave on the liquid system; and, determine the property of the test substance based on parameters of the surface wave; wherein the method for controlling the sensor comprises: controlling the dynamic range by changing a thermodynamic parameter of the liquid system.

A method is provided to adjust the dynamic range of the sensor. In adjusting the dynamic range, two difference analytes (e.g. test substances) each generating different characteristic signals can be identified using the same apparatus.

In examples, the method may comprise obtaining an indication of at least one thermodynamic parameter of the liquid system. The indication may be the change in intensity of light reflected from the lipid monolayer.

In examples, the method may comprise controlling the thermodynamic parameter of the liquid system based on the indication of the same thermodynamic parameter of the liquid system. The method may comprise controlling the lateral surface pressure based on indications (i.e. measurements) of changes in the lateral surface pressure. In such examples, changes in the lateral surface pressure may be measured directly using a Wilhelmy balance.

In examples, the method may comprise controlling the thermodynamic parameter of the liquid system based on the indication of another thermodynamic parameter of the liquid system. The method may comprise controlling the lateral surface pressure based on indications (i.e. measurements) of changes in the intensity of light reflected from the lipid monolayer. In such examples, the changes in intensity of light reflected from the lipid monolayer may be measured using an optical sensor.

A means of converting the measured changes in intensity of light reflected from the lipid monolayer to the corresponding changes in lateral surface pressure may be provided. For example, a processor of the optical sensor may be provided which may configured to perform said conversion.

In examples, the method may comprise controlling the dynamic range by changing a thermodynamic parameter of the liquid system comprises controlling the lateral surface pressure of the liquid system.

The dynamic range of the sensor may be inversely proportional to the optomechanical susceptibility of the lipid monolayer. Controlling the lateral surface pressure of the lipid monolayer may control the optomechanical susceptibility of the lipid monolayer, which therefore controls the dynamic range of the sensor.

In examples, the method may comprise the lateral surface pressure of the liquid system is changed by changing the surface area of the liquid system. For example, a movable barrier of the state control means may be configured to change the surface area of the lipid monolayer.

In examples, the thin film is a monolayer. The bulk liquid phase may comprise an aqueous solution. The liquid system may comprise film material dispersed in the bulk liquid phase.

In examples, after an analyte has been contacted to the surface of a liquid system and appropriate measurements of the generated waves are made, then the liquid system is emptied and replaced with a new liquid system which is identical to the previous medium.

An aspect of the disclosure provides the sensor for determining a property of a test substance, the sensor having a sensitivity and dynamic range, the sensor comprising: a trough for holding a liquid system; a liquid system comprising: a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system, the sensor configured to: contact the surface of the liquid system with the test substance thereby to generate a surface wave on the liquid system; and, determine the property of the test substance based on parameters of the surface wave; the sensor comprising a state control means configured to control the sensitivity by changing a thermodynamic parameter of the liquid system.

### DRAWINGS

Embodiments of the disclosure will now be described, by way of example only, with reference to the accompanying drawings, in which:

FIG. 1 illustrates a side view of an analytical apparatus for performing an analytical method;

FIG. 2 illustrates a pair of axes representing lateral surface pressure of a lipid monolayer (x-axis) against the opto-mechanical susceptibility ψ of a flowing liquid system;

FIG. 3 illustrates a flowchart depicting a method of controlling the sensitivity of the sensor of FIG. 1;

FIG. 4 illustrates a flowchart depicting a method of controlling the sensitivity of the sensor of FIG. 1;

FIG. 5A illustrates a side view of a reservoir computing unit;

FIG. 5B is a simplified top-down schematic view of a reservoir computing unit having two inputs;

FIG. 6 is a schematic view of a first reservoir computing system comprising a plurality of reservoir computing units;

FIG. 7 is a schematic view of a second reservoir computing system 700 comprising a plurality of reservoir computing units.

Like reference signs between the Figures illustrate like elements.

### SPECIFIC DESCRIPTION

The methods described herein relate to controlling a sensor wherein the sensor is configured to determine a property of a test substance. The sensor comprises a liquid system, wherein the liquid system comprises a bulk liquid phase carrying a thin film on the surface of the bulk liquid phase. Methods comprise controlling the sensor by controlling the thermodynamic state of the liquid system. Controlling the thermodynamic state of the liquid system amounts to controlling one or more thermodynamic property of the liquid system. Controlling the thermodynamic state of the liquid system controls properties of the sensor, for example, the sensitivity of the sensor and the dynamic range of the sensor.

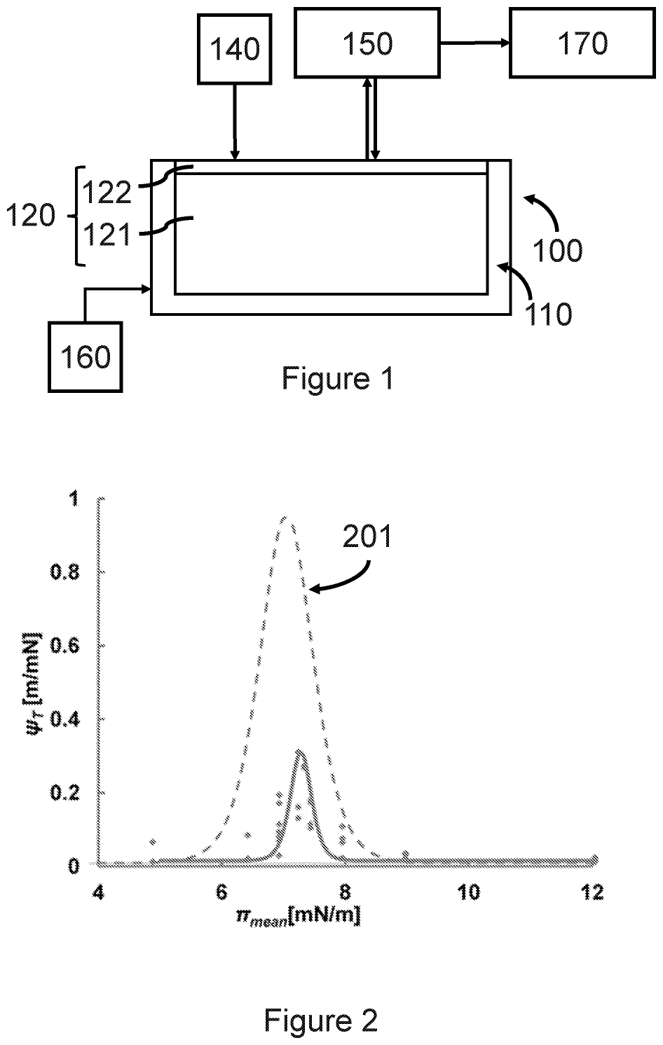

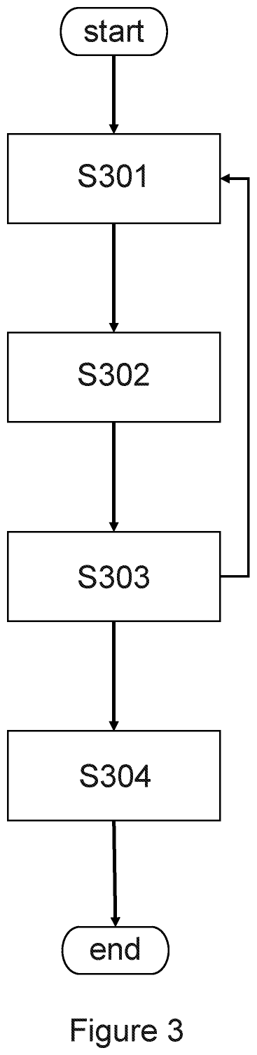

FIG. 1 illustrates a cross-sectional view of a sensor 100. The sensor 100 comprises: a trough 110; a liquid system 120; a contacting means 140; a detector 150; and a state control means 160. The detector 120 is commutatively coupled to a computer terminal 170.

In examples, the sensor comprises the computer terminal.

The trough 110 comprises a bottom and sides which define an interior volume. The trough may be a Langmuir trough. The interior volume of the trough 110 is configured to hold the liquid system 120.

The trough 110 has a width e.g. the dimension perpendicular to the plane of the page. The trough 110 has a length e.g. the dimension within the plane of the page. The width is selected to be greater than the wavelength of surface waves generated by contacting a substance with the surface of a liquid system disposed in the trough. Such an arrangement may avoid or reduce the magnitude of undesired wave mechanics (e.g. diffraction; reflection; self-interference) which might complicate the generated surface waves.

Complicating the generated surface waves can be undesirable because doing so may increase the computational work required to determine one or more parameters of the surface waves and/or to determine a property of the test substance which generates the wave.

In examples, the wavelengths of surface waves generated by contacting a substance with the surface of a liquid system disposed in the trough vessel will be on the order of a millimetre (10⁻³ m) to the order of a centimetre (10⁻² m). Advantageously, a trough vessel with a width on the order of decimetres (10⁻¹ m) may be provided to thereby negate or avoid the aforementioned problems but without unnecessarily increasing the size of the analytical sensor.

Typically, sources of randomness which might affect the characteristics of the generated surface waves include: vibrations due to a user bumping into a table holding the sensor; vibrations due to traffic which vibrate a table holding the sensor. Ideally these factors are controlled and/or their influence on the liquid system are reduced or minimised. For example, the trough may be disposed in a cradle wherein the cradle isolates the trough from external vibrations.

The liquid system 120 comprises a bulk liquid phase 121 and a thin film 122 carried at the surface of the bulk liquid phase 121 i.e. the thin film floats 122 on top of the bulk liquid phase 121. The thin film 122 forms a boundary or interface with an adjacent medium, which in practice, is air. The thin film 122 comprises a film material and film material dispersed in the bulk liquid phase. In the present example, the thin film 122 is a lipid monolayer.

The surface of the liquid system forms a boundary or interface with any adjacent medium, typically air or another gas. In the present example, the interface between the lipid monolayer 122 and air is referred to as the lipid interface.

Measurable parameters of the lipid monolayer 122 are thermodynamically coupled e.g. an electrical response is generated in response to mechanical stress and vice versa. The parameters of the liquid system 120 are a combination of parameters of the lipid monolater 122 and parameters of the bulk liquid phase 121 (e.g. this follows from the general principle that parameters of a given surface are thermodynamically independent of the parameter of the volume enclosed by said surface).

The contacting means 140 is disposed above the trough 110. The contacting means 140 is configured to contact the surface of the liquid system 120, in this example, the lipid monolayer 122, with a droplet of a test substance.

In the present example, the contacting means 140 is configured to: form a droplet of the test substance at a contacting means outlet; and, move the contacting means outlet toward the surface of the liquid system (in this example, the lipid monolayer 122) to thereby bring into contact the droplet of the test substance and the lipid monolayer 122.

In examples, the contacting means may be configured to: form a droplet of a test substance at an outlet of the contacting means; wherein, in use, the outlet of the contacting means is spaced from the surface of the liquid system so that, in the event that a droplet is formed at the outlet, part of the droplet contacts the surface resulting in mixing between the droplet of the test substance and the liquid system.

In examples, the contacting means may be configured to drop a droplet of the test substance onto the surface of the liquid system. A disadvantage with dropping a droplet onto the surface of the liquid system (compared to contacting a surface of a liquid system with a droplet) is that the dropped droplet can rebound thereby generating a plurality of waves which may require a greater amount of computational work to determine parameter of the generated waves and/or a property of the dropped test substance which generates the wave. An advantage with dropping the droplets onto the surface is that because it rebounds the mixing of the droplet of the test substance with the bulk liquid phase may be avoided and the surface wave excited may be indicative of only the surface properties of the droplet until the droplet breaks and mixes.

Upon contact of a droplet of the test substance with the surface of the liquid system, the surface of the liquid system 120 (i.e. the lipid monolayer 122) and the droplet of the test substance interact with one another. For example, there is a thermodynamic interaction between the test substance and the lipid monolayer 122 i.e. the enthalpy of the lipid monolayer is changed by the test substance. In examples, there is a chemical interaction between the test substance and the lipid monolayer 122.

The interaction between the surface of the liquid system 120 (i.e. the lipid monolayer 122) and the test substance is referred to as a perturbation of the sensor.

The perturbation induces a response of the sensor 100. In the present example, the response is one or more surface wave modes (e.g. Lucassen waves) generated in the lipid monolayer 122.

A wave parameter of each mode (e.g. the amplitude, or speed or frequency of the wave) is indicative of a property of the test substance (e.g. viscosity, charge etc.). In examples, changes in the lateral surface pressure π of the lipid monolayer 122 (an example of a thermodynamic parameter of the liquid system) can be used to determine the amplitude of a wave propagating through the lipid monolayer 122.

In the example illustrated in FIG. 1, the detector 150 is an optical detector. The optical detector 150 comprises a light source and a light detector. The detector 150 is configured to detect a parameter of a surface wave of a liquid system disposed in the trough. The light source is arranged to direct light onto a surface of the liquid system 120 held in the trough 110.

The intensity of the light reflected at a given location on the surface of the liquid system 120 depends on the polarization and angle of incidence at the surface and on the density and orientation of lipid molecules at of the thin film 122, which determine the dielectric properties of the surface.

The intensity of the reflected light at a given point on the surface for a fixed angle of incidence and polarisation is increased when the density of the lipid monolayer 122 at the given point is greater. Increases in the density of the lipid monolayer 122 correspond to increases in the lateral surface pressure of the lipid monolayer 122.

The intensity of the reflected light at a given point on the surface for a fixed angle of incidence and polarisation is reduced when the lipid density is comparatively lesser at the given point. Decreases in the density of the lipid monolayer 122 correspond to decreases in the lateral surface pressure of the lipid monolayer 122.

Changes in the lateral surface pressure π of the lipid monolayer 122 result in corresponding changes to the intensity, I, of the light reflected from the lipid monolayer 122. The strength of this coupling is described by the optomechanical susceptibility of the lipid monolayer and is described in more detail herein.

The optical detector 150 detects light reflected from the lipid monolayer 122 and generates a signal indicative of the intensity of the reflected light. The measurements of intensity are sent to a processor in the optical detector 150. Said processor stores known properties of the lipid monolayer (e.g. the wave speed). The processor in the optical detector is configured to determine the amplitude of the wave in the lipid monolayer 122. The processor is configured to determine the time between two adjacent maxima (e.g. the time between measuring a first maximum in intensity and a second maxima). The determined time and the stored wave speed, can be used to determine the amplitude of the wave. As described herein, the amplitude of the wave is indicative of a property of the test substance.

The optical detector 150 sends the determined amplitude of the wave to the computer terminal 170 to determine a property of the test substance based on the amplitude of the wave.

The optical detector 150 is communicatively coupled to the computer terminal 170. The determined amplitude generated by the optical detector 150 are sent to the computer terminal 170. A database is stored on the computer terminal 170. The database comprises database entries wherein each database entry comprises known measurements amplitudes of known substance and an associated label identifying the value of the property of the substance.

The determined amplitude is compared to the database entries to determine if there is a similarity between the determined amplitude and the database entries. If there is a similarity between the signal and an entry of the database, then the computer terminal 170 returns the associated label to a display of the computer terminal to inform a user of the sensor of the identity of the test substance. If there is not a sufficient similarity between the signal and an entry of the database, then the computer terminal 170 returns a message to a display of the computer terminal to inform a user of the sensor that the identity of the test substance cannot be determined.

In examples, the optical detector may send the raw intensity measurements to the computer terminal and the computer terminal may identify the property of the substance based on either the raw intensity measurements or the computer terminal may determine an amplitude of the wave and use this to determine a property of the test substance.

It will be understood by those skilled in the art that the detector 150 can be replaced by any detector configured to determine a thermodynamic parameter of the liquid system. For example, a surface potential detector can be used. The surface potential detector is configured to measure the surface potential of the surface of the liquid system which may be associated to a parameter of waves in the liquid system. In examples, wherein the liquid system comprises a lipid monolayer, a generated wave in the lipid monolayer results in variations of the charge density on the surface which effect the polarisation of the reflected light.

The state control means is configured to control the state of the liquid system by controlling at least one of the thermodynamic parameters of the liquid system. The thermodynamic parameters of the liquid system 120 are changed using the state control means 160. In the present example, the state control means 160 comprises a moveable barrier configured to change the surface area of the liquid system. The state control means 160 comprises a processor and a storage. The function of the state control means 160 in changing the sensitivity and/or dynamic range of the liquid system is described in more detail herein.

In use, the sensor 100 is operated in the following manner. A droplet of a test substance is generated by the contacting means 140. The contacting means 140 is operated to contact the surface of the liquid system 120 (i.e. the lipid monolayer 122) with the droplet of the test substance. The test substance perturbs the lipid monolayer 122.

In response to the perturbation, a surface wave is generated in the lipid monolayer 122. The detector 150 obtains an indication of the surface wave by measuring a parameter of the surface wave. In the present example, the detector 150 measures changes in the intensity of reflected light from the lipid monolayer 122 which are indicative of changes in the lateral surface pressure of the lipid monolayer caused by the wave.

The processor of the optical detector 150 determines the amplitude of the generated surface wave based on the measured changes in the intensity of the reflected light. The determined amplitude is sent to the computer terminal 170. The computer terminal compares the determined amplitude to entries of the database to determine the most similar database entry to the determined amplitude. The value of the property of the test substance associated with the database entry which is determined to be the most similar to the determined amplitude is sent to a display of the computer terminal. This value is the determined value of the property of the test substance.

In examples, the lipid monolayer may comprise fluorescent dye molecules. Advantageously, the fluorescent dye molecules are sensitive to dynamic changes in the thermodynamic state of the liquid system, for example, changes in lateral surface pressure in the lipid monolayer. Regions of high lateral surface pressure are regions of relatively high molecular density of the lipid monolayer and, therefore, such regions will emit light which is more intense in comparison to regions of relatively low lateral surface pressure. e.g In examples the intensity of the light may depend on any of: a higher density of fluorescent molecules at these regions, the solvation of the dye and the orientation of the dye molecules with respect to an optical field (e.g. Shrivastava et al. Opto-Mechanical Coupling in Interfaces under Static and Propagative Conditions and Its Biological Implications and Shrivastava et al. On measuring the acoustic state changes in lipid membranes using fluorescent probes).

### Sensitivity

The sensitivity of the sensor is the minimum magnitude of response of the liquid system which is measurable by the detector of the sensor.

In the present example, the optical detector 150 measures the intensity of reflected light from the surface of the liquid system 120. Changes to the intensity of light reflected from the surface of the liquid system 120 are indicative of changes of lateral surface pressure of the liquid system 120.

In the present example, the sensitivity of the sensor 100 is the minimum change in lateral surface pressure of the lipid monolayer 122 of the liquid system 120 which is measurable by the optical detector 150 of the sensor 100.

A response is induced in the lipid monolayer 122 of the liquid system 120 when a droplet of a test substance is contacted on the lipid monolayer 122 carried at the surface of the liquid system 120. The response is a surface wave generated in the lipid monolayer 122. A parameter of the surface wave is indicative of a property of the test substance. Parameters of a surface wave include any of: amplitude, wavelength, wave frequency, and wave speed. A parameter of a surface wave can be determined based on changes in lateral surface pressure of the lipid monolayer 122 when the generated surface wave propagates therethrough.

In examples, more than one surface wave is generated in the lipid monolayer 122 in when a droplet of a test substance is contacted on the lipid monolayer i.e. several wave modes are generated in the lipid monolayer. In such examples, each wave mode may be indicative of a property of the test substance.

The present disclosure provides a means of inferring the lateral surface pressure by measuring the intensity of light reflected from the surface of the lipid monolayer 122. The intensity, I, of light reflected from the lipid monolayer 122 is coupled to the magnitude of the lateral surface pressure, π, of the lipid monolayer 122.

The strength of the coupling between the lateral surface pressure, π, and the intensity, I, of reflected light is proportional to the optomechanical susceptibility ψ of the lipid monolayer 122. The optomechanical susceptibility ψ of the lipid monolayer 122 is proportional to the ratio between a change in intensity, ΔI, of reflected light from the lipid monolayer and a corresponding change in lateral surface pressure, Δπ, of the liquid system. This can be expressed mathematically as:

$$ψ ∝ \frac{Δ I}{Δπ}$$

As stated above, the sensitivity of the sensor is the minimum magnitude of response of the liquid system which is measurable by the detector of the sensor. In the present example, the sensitivity refers to the minimum change in lateral surface pressure, Δπ, of the lipid monolayer 122 which is measurable by the optical detector 150. The minimum change in lateral surface pressure, Δπ, of the lipid monolayer 122 is measurable when the optomechanical susceptibility ψ is a maximum (or as close to maximum is possible in the lipid monolayer 122). Therefore, the maximum sensitivity of the sensor 100 of the present example occurs when the optomechanical susceptibility ψ is a maximum (or as close to maximum is possible in the lipid monolayer 122).

Likewise, the minimum sensitivity of the sensor 100 of the present example occurs when the optomechanical susceptibility ψ is a minimum (or as close to minimum is possible in the lipid monolayer 122).

Therefore, the sensitivity, S, of the sensor is proportional to the optomechanical susceptibility ψ. This may be expressed mathematically as:

$$S ∝ ψ$$

FIG. 2 illustrates a pair of axes representing lateral surface pressure of a lipid monolayer (x-axis) against the opto-mechanical susceptibility ψ of the lipid monolayer 122 of the liquid system 120. There is a curve relative to the axes a first curve 201 which illustrates the optomechanical susceptibility ψ when the state of the liquid system 120. This curve 201 can be obtained using the methods described in Shrivastava S, Schneider M F (2013) Opto-Mechanical Coupling in Interfaces under Static and Propagative Conditions and Its Biological Implications. PLOS ONE 8 (7): e67524). The maximum of the optomechanical susceptibility occurs at the phase transition of the lipid monolayer 122 from a liquid-expanded (LE) state to liquid-condensed (LC) state (i.e. the LE-LC phase transition).

The sensitivity of the sensor 100 is proportional to the thermodynamic susceptibility of the lipid monolayer 122, therefore, the sensitivity of the sensor 100 is controllable by controlling the optomechanical susceptibility ψ of the lipid monolayer 122. The optomechanical susceptibility ψ of the lipid monolayer 122 depends on the thermodynamic state of the liquid system 120.

The sensor 100 comprises the state control means 160. The state control means 160 is configured to control the thermodynamic state of the liquid system 120. The state control means 160 controls the thermodynamic state of the liquid system 120 by controlling (e.g. changing and maintaining at specific values) thermodynamic parameters which define the state of the liquid system 120.

A generated surface wave comprises: a change in lateral surface pressure of the liquid system propagating away from the site of perturbation. As described herein, the lateral surface pressure is a thermodynamic parameter of the liquid system 120. Measurements of the lateral surface pressure by optical sensor 150 are used to determine the amplitude of a surface wave propagating through the lipid monolayer 122.

Set out below is a method of controlling the sensor 100 to thereby adjust its sensitivity. In particular the method involves controlling the sensor 100 to adjust the strength of the coupling between the intensity of light reflected from the lipid monolayer 122 and the lateral surface pressure of the lipid monolayer π.

The sensor 100 is the same as that described above with reference to FIG. 1. The sensor 100 has an optical sensor 150 and liquid system 120 comprising a lipid monolayer 122.

The state control means 160 is used to control the absolute value of the lateral surface pressure changes the value of the optomechanical susceptibility.

In the present example, the state control means 160 comprises a movable barrier (e.g. a movable barrier of a Langmuir trough) which is operable to increase and decrease the surface area of the lipid monolayer 122. As described herein, changing the surface area of the lipid monolayer 122 changes the lateral surface pressure of the lipid monolayer. The state control means 160 is operable to increase the lateral surface pressure of the lipid monolayer 122 (i.e. by reducing the surface area of the lipid monolater 122). The state control means 160 is operable to decrease the lateral surface pressure of the lipid monolayer 122 (i.e. by increasing the surface area of the lipid monolayer 122).

A method of controlling the sensitivity is described below.

Contacting, S301, a lipid monolayer carried on the surface of the liquid system with a droplet of a test substance to generate a surface wave in the lipid monolayer.

A droplet of the test substance is formed at the contacting means outlet and then the contacting means outlet is moved toward the lipid monolayer 122 to thereby bring into contact the droplet of the test substance and the lipid monolayer 122.

Obtaining, S302, an indication of the surface wave generated in the lipid monolayer 122.

As is described herein, the indication of a parameter of the surface wave can be used to determine a property of the test substance. In the present example, an indication of the amplitude of the surface wave is obtained by the optical sensor 150.

The optical sensor 150 is configured to obtain changes in intensity of light reflected from the lipid monolayer 122 over a period of time. The changes in intensity are related to changes in lateral surface pressure of the lipid monolayer 122 which in turn can be used to determine the amplitude of the surface wave in the manner described below.

The indication of change in lateral surface pressure of a surface wave generated in the lipid monolayer 122 is obtained by the measurement of the intensity of light reflected from the surface of the lipid monolayer 122 as a function of time. The intensity, I, of reflected light and lateral surface pressure, π, are coupled such that change in the intensity, I, of reflected light results from a corresponding change in the lateral surface pressure, π, of the lipid monolayer 122. Therefore, the optical detector 150 can be used to take measurements of the intensity, I, of light reflected from the lipid monolayer 122 and these measurements can be used to infer the corresponding changes in the lateral surface pressure, π.

The optical detector 150 measures the intensity of light reflected from a point on the surface of the lipid monolayer 122 over a preselected time period (e.g. for 5 seconds). As the surface wave propagates through the point being measured by the optical detector 150, the intensity of light reflected from that point of surface of the lipid monolayer 122 will change.

The measurements of intensity are sent to a processor in the optical detector 150. Said processor stores known properties of the lipid monolayer (e.g. the wave speed). The processor in the optical detector is configured to determine the amplitude of the wave in the lipid monolayer 122. The processor is configured to determine the time between two adjacent maxima (e.g. the time between measuring a first maximum in intensity and a second maxima). The determined time and the stored wave speed, can be used to determine the amplitude of the wave. As described herein, the amplitude of the wave is indicative of a property of the test substance.

In examples instead of measuring the intensity of light reflected from a point on the lipid monolayer over a period of time, a snapshot can be taken of a portion of the lipid monolayer (e.g. a photograph) which can be used to determine the amplitude of the surface wave. In such examples, peaks in the surface waves (i.e. points of maximum displacement of the wave) can be visually identified on the photograph and the distance between two such peaks can be measured. The distance between two adjacent peaks is the amplitude of the surface wave.

Determining S303, if the sensitivity of the sensor requires increasing.

If two maxima can be identified, then the processor of the optical detector 150 determines that the sensitivity of the sensor 100 should not be increased. In the event that the optical detector 150 determines that the sensitivity of the sensor 100 should not be increased, no further action is required, and the sensor may be used for subsequent analysis e.g. the lipid monolayer can be contacted with another droplet of the test substance or with a droplet of another test substance.

If no maxima can be identified, then the processor of the optical detector 150 determines that the sensitivity of the sensor 100 should be increased. In the event that the optical detector 150 determines that the sensitivity of the sensor 100 should be increased, the optical detector 150 sends a sensitivity signal to the state control means 160, wherein the sensitivity signal instructs the state control means to change the sensitivity of the sensor.

Changing, S304, the lateral surface pressure π of the lipid monolayer 122 to increase the sensitivity of the sensor 100.

The state control means 160 is configured to change the lateral surface pressure IT of the liquid system. Changing the lateral surface pressure IT of the lipid monolayer 122 changes the optomechanical susceptibility ψ of the lipid monolayer 122. The optomechanical susceptibility ψ of the lipid monolayer 122 is proportional to the sensitivity of the sensor 100. Therefore, changing the lateral surface pressure of the liquid system changes the sensitivity of the sensor 100.

The state control means 160 receives the sensitivity signal from the optical sensor 150. The sensitivity signal comprises an indication of the lateral surface pressure π of the lipid monolayer 122.

The state control means 160 comprises a computing means comprising a processor and a storage. The storage of the state control means comprises a database wherein entries of the database comprise a given lateral surface pressure π of the lipid monolayer 122 associated with a value of the optomechanical susceptibility ψ of the lipid monolayer 122 for the given lateral surface pressure π of the lipid monolayer 122. The processor of the state control means 160 converts indications of the intensity of the reflected light into an associated lateral surface pressure using the database.

The state control means 160 compares the lateral surface pressure π of the sensor signal to the entries of the database. The state control means 160 determines a database entry with a lateral surface pressure π which is most similar to the lateral surface pressure of the sensor signal. The state control means 160 reads the value of the optomechanical susceptibility ψ associated of the determined database entry.

In the present example, the processor of the state control means 160 determines the required change in the lateral surface pressure π (increase or a decrease) required to increase the optomechanical susceptibility ψ. In examples, the state control means 160 may be configured to maximise the optomechanical susceptibility ψ (and, therefore, the sensitivity of the sensor 100).

Alternatively, in examples, the state control means 160 may be configured to incrementally increase and/or decrease the lateral surface pressure π to increase the optomechanical susceptibility ψ and perform steps S301 to S303 again until two maxima are detected.

If the lateral surface pressure needs to be increased in order to increase the optomechanical susceptibility, then the state control means 160 operates a movable barrier to reduce the surface area of the lipid monolayer 122.

If the lateral surface pressure needs to be decreased in order to increase the optomechanical susceptibility, then the state control means 160 operates a movable barrier to increase the surface area of the lipid monolayer 122.

It will be readily understood by one skilled in the art that this general principle of controlling the sensor to comparatively increase or maximise a given susceptibility can be applied to any susceptibility and its associated coupled thermodynamic parameters. For example, the sensor can be controlled to comparatively increase or maximise the generic susceptibility of two thermodynamic parameters X & Y:

$${ψ}_{X - Y} ∝ \frac{δ X}{δ Y} .$$

Therefore, increasing the susceptibility of two thermodynamic parameters X & Y ψ_{X-Y} comparatively increases strength of the coupling between the two parameters. In other words, increasing the susceptibility ψ_{X-Y} means, ceteris paribus, a given magnitude of change in X will produce a greater magnitude of change in Y i.e. because δX∝ψ_{X-Y}. δY.

### Dynamic Range

The dynamic range of the sensor 100 is measure of the range of response values which can be distinguished in a given thermodynamic state of the liquid system 120. It may be expressed as the ratio of the maximum measurable wave response which is recorded by the detector of the sensor to the minimum measurable wave response of the liquid system which is recorded by the detector of the sensor.

$$DR = \frac{maximum measurable response}{minimum measurable response}$$

The sensitivity of the sensor, S, is related to the minimum magnitude of wave response of the liquid system which is recorded by the detector of the sensor. The maximum magnitude of response occurs at the saturation value of the liquid system 120. Therefore, the dynamic range can be expressed mathematically as:

$$DR = \frac{saturation value}{S}$$

As described above, in the case of Lucassen waves the sensitivity of the sensor 100 is proportional to the optomechanical susceptibility of the lipid monolayer 122. The dynamic range, DR, is inversely proportional to the sensitivity, S. The saturation value on the other hand is dependent on what aspect of the wave is considered for sensing application. For example, if it is the amplitude of the Lucassen wave the saturation value is the difference between the maximum value to which the film can be compressed laterally, and the initial density of the film. In a lipid monolayer, the maximum compression is limited by the chemical potential of a molecule in the compressed state vs the bulk liquid. Therefore the saturation value is different for different composition of the films and can be further adjusted by changing salt or pH composition of the bulk. This is one way to change the dynamic range.

Clearly both saturation value and sensitivity are dependent on the thermodynamic state of the liquid system and strongly coupled. Therefore to improve the performance of the sensor the state of the liquid system can be selected in a way that optimises both sensitivity and saturation simultaneously for a given application.

For completeness, we note that the saturation value may depend on the state of the liquid system i.e. in examples, changing the state of the liquid system changes the saturation value.

The sensor 100 comprises the state control means 160. The state control means 160 is configured to control the thermodynamic state of the liquid system 120. The state control means 160 controls the thermodynamic state of the liquid system 120 by controlling (e.g. changing and maintaining at specific values) thermodynamic parameters which define the state of the liquid system 120.

Set out below is a method of controlling the sensor 100 to thereby adjust its dynamic range. In particular the method involves controlling the sensor 100 to adjust the strength of the coupling between the intensity of light reflected from the lipid monolayer 122 and the lateral surface pressure of the lipid monolayer π.

The sensor 100 is the same as that described above with reference to FIG. 1. The sensor 100 has an optical sensor 150 and liquid system 120 comprising a lipid monolayer 122.

The state control means 160 is used to control the absolute value of the lateral surface pressure changes the value of the optomechanical susceptibility.

In the present example, the state control means 160 comprises a movable barrier (e.g. a movable barrier of a Langmuir trough) which is operable to increase and decrease the surface area of the lipid monolayer 122. As described herein, changing the surface area of the lipid monolayer 122 changes the lateral surface pressure of the lipid monolayer. The state control means 160 is operable to increase the lateral surface pressure of the lipid monolayer 122 (i.e. by reducing the surface area of the lipid monolater 122). The state control means 160 is operable to decrease the lateral surface pressure of the lipid monolayer 122 (i.e. by increasing the surface area of the lipid monolayer 122).

A method of controlling the dynamic range is described below.

Contacting, S401, a lipid monolayer carried on the surface of the liquid system with a droplet of a test substance to generate a surface wave in the lipid monolayer.

A droplet of the test substance is formed at the contacting means outlet and then the contacting means outlet is moved toward the lipid monolayer 122 to thereby bring into contact the droplet of the test substance and the lipid monolayer 122.

Obtaining, S402, an indication of the surface wave generated in the lipid monolayer 122.

As is described herein, the indication of a parameter of the surface wave can be used to determine a property of the test substance. In the present example, an indication of the amplitude of the surface wave is obtained by the optical sensor 150.

The optical sensor 150 is configured to obtain changes in intensity of light reflected from the lipid monolayer 122 over a period of time. The changes in intensity are related to changes in lateral surface pressure of the lipid monolayer 122 which in turn can be used to determine the amplitude of the surface wave in the manner described below.

The indication of change in lateral surface pressure of a surface wave generated in the lipid monolayer 122 is obtained by the measurement of the intensity of light reflected from the surface of the lipid monolayer 122 as a function of time. The intensity, I, of reflected light and lateral surface pressure, π, are coupled such that change in the intensity, I, of reflected light results from a corresponding change in the lateral surface pressure, π, of the lipid monolayer 122. Therefore, the optical detector 150 can be used to take measurements of the intensity, I, of light reflected from the lipid monolayer 122 and these measurements can be used to infer the corresponding changes in the lateral surface pressure, π.

The optical detector 150 measures the intensity of light reflected from a point on the surface of the lipid monolayer 122 over a preselected time period (e.g. for 5 seconds). As the surface wave propagates through the point being measured by the optical detector 150, the intensity of light reflected from that point of surface of the lipid monolayer 122 will change.

The measurements of intensity are sent to a processor in the optical detector 150. Said processor stores known properties of the lipid monolayer (e.g. the wave speed). The processor in the optical detector is configured to determine the amplitude of the wave in the lipid monolayer 122. The processor is configured to determine the time between two adjacent maxima (e.g. the time between measuring a first maximum in intensity and a second maxima). The determined time and the stored wave speed, can be used to determine the amplitude of the wave. As described herein, the amplitude of the wave is indicative of a property of the test substance.

In examples instead of measuring the intensity of light reflected from a point on the lipid monolayer over a period of time, a snapshot can be taken of a portion of the lipid monolayer (e.g. a photograph) which can be used to determine the amplitude of the surface wave.

Determining S403, if the dynamic range of the sensor 100 requires changing.

If two maxima can be identified, then the processor of the optical detector 150 determines that the dynamic range of the sensor 100 should not be changed. In the event that the optical detector 150 determines that the dynamic range of the sensor 100 should not be changed, then no further action is required, and the sensor may be used for subsequent analysis e.g. the lipid monolayer can be contacted with another droplet of the test substance or with a droplet of another test substance.

If no maxima can be identified, then the processor of the optical detector 150 determines that the dynamic range of the sensor 100 should be changed. For example, the dynamic range may be too narrow for the sensor to sense surface waves with amplitudes in a specific range. In the event that the optical detector 150 determines that the dynamic range of the sensor 100 should be changed, the optical detector 150 sends a dynamic range signal to the state control means 160, wherein the dynamic range signal instructs the state control means to change the dynamic range of the sensor.

Changing, S404, the lateral surface pressure π of the lipid monolayer 122 to change the dynamic range of the sensor 100.

The state control means 160 is configured to change the lateral surface pressure π of the liquid system. Changing the lateral surface pressure π of the lipid monolayer 122 changes the optomechanical susceptibility ψ of the lipid monolayer 122. The optomechanical susceptibility ψ of the lipid monolayer 122 is inversely proportional to the dynamic range of the sensor 100. Therefore, changing the lateral surface pressure of the liquid system changes the dynamic range of the sensor 100.

The state control means 160 receives the dynamic range signal from the optical sensor 150. The sensitivity signal comprises an indication of the lateral surface pressure π of the lipid monolayer 122.

The state control means 160 comprises a computing means comprising a processor and a storage. The storage of the state control means comprises a database wherein entries of the database comprise a given lateral surface pressure π of the lipid monolayer 122 associated with a value of the optomechanical susceptibility ψ of the lipid monolayer 122 for the given lateral surface pressure π of the lipid monolayer 122. The processor of the state control means 160 converts indications of the intensity of the reflected light into an associated lateral surface pressure using the database.

The state control means 160 compares the lateral surface pressure π of the sensor signal to the entries of the database. The state control means 160 determines a database entry with a lateral surface pressure π which is most similar to the lateral surface pressure of the sensor signal. The state control means 160 reads the value of the optomechanical susceptibility ψ associated of the determined database entry.

In the present example, the processor of the state control means 160 determines the required change in the lateral surface pressure π (increase or a decrease) required to change in the optomechanical susceptibility ψ. In examples, the state control means 160 may be configured to reduce the optomechanical susceptibility ψ (and, therefore, the increase the dynamic range of the sensor 100).

Alternatively, in examples, the state control means 160 may be configured to incrementally increase and/or decrease the lateral surface pressure π to increase and/or decrease the optomechanical susceptibility ψ and perform steps S301 to S303 again until the dynamic range provided is suitable to measure two maxima.

If the lateral surface pressure needs to be increased in order to increase the optomechanical susceptibility, then the state control means 160 operates a movable barrier to reduce the surface area of the lipid monolayer 122.

If the lateral surface pressure needs to be decreased in order to increase the optomechanical susceptibility, then the state control means 160 operates a movable barrier to increase the surface area of the lipid monolayer 122.

The sensor 100 described herein comprises an optical detector 150, however, it will be appreciated by those of ordinary skill in the art that the optical detector 150 can be replaced with any sensor configured to obtain an indication of a surface wave in the lipid monolayer 122 wherein the surface wave is generated as a response to a perturbation.

For example, a Wilhelmy plate could be used to obtain an indication of a surface wave in the lipid monolayer. When a Wilhelmy plate is used, the indication of the surface wave is the interfacial tension of the lipid-air interface.

Depending on the property of the surface wave which is being measured by the detector, the sensitivity may depend on: lateral compressibility i.e. change in surface area per change in lateral surface pressure of the liquid system; heat capacity (i.e. change in enthalpy per change in temperature of the liquid system); compressibility (i.e. change in volume (or in examples, change in density) per change in pressure); electric susceptibility (i.e. change in electrical polarization of the surface and/or the bulk liquid phase of the liquid system in response to an applied electric field); chemical susceptibility (i.e. change in degree of chemical association of components of the liquid system in response to a chemical potential); thermal expansion coefficients (i.e. change in surface area or volume of the liquid system in response to change in temperature); electromechanical coupling coefficient (i.e. change voltage in response to an applied pressure); magnetic susceptibility (i.e. change in magnetic polarization of the surface of the liquid system and/or the bulk liquid phase of the liquid system in response to an applied magnetic field).

By analogy to the example of sensitivity described above which depends on the magnitude of the opto-mechanical coupling, the relevant sensitivity which depends any of the aforementioned compressibilities will also depend on the magnitude of said compressibilities.

Any thermodynamic susceptibility depends on the thermodynamic condition under which the response is measured. A thermodynamic condition is characterised by one or more thermodynamic variables which is held constant. In examples, the state control means is used to main a thermodynamic condition of the liquid system. Example thermodynamic conditions are: an adiabatic condition (i.e. a liquid system is maintained at constant heat and mass); an isothermal condition (i.e. a liquid system is maintained at a constant temperature); etc.

The sensor can be controlled to change at least one of the sensitivity and dynamic range. The sensor is controlled to change at least one of the thermodynamic parameters of the liquid system which in turn changes the state of the liquid system. The value of the thermodynamic susceptibilities of the system depend on the state of the liquid system 120.

Thermodynamic parameters of the liquid system which can be controlled to thereby change the state of the liquid system include: Mass; Energy, E; Enthalpy, H; Internal energy, U; Gibbs free energy, G; Helmholtz free energy, F; Exergy, B; Entropy, S; Pressure, P; Temperature, T; Volume, V; Chemical composition (e.g. lipid-type); Specific volume, v; Particle number, nᵢ; surface density of lipid molecules; the surface area of the thin film; the lateral surface pressure of the lipid thin film, π; the surface tension of the lipid thin film, γ; the surface concentration of the lipid thin film Γ; the surface potential of the lipid thin film ΔV; the surface elastic modulus of the lipid thin film, the capacitance of the thin film; the heat capacity of the thin film; E; pH of the liquid system; ion or protein adsorption; solvent incorporation; the concentration of the film material dispersed in the liquid system; an electromagnetic field applied to the liquid system; the conformation of the molecules of the thin film.

It will be understood by one of ordinary skill in the art that the thermodynamic parameters of the liquid system (and therefore the state of the liquid system) can be controlled using a state control means comprising one or more devices.

In the specific example described herein the state control means comprises a movable barrier configured to change the surface area of the liquid system. As described herein changing the surface area of the liquid system changes the lateral surface pressure of the liquid system and as such, the state of the liquid system can be controlled in this manner.

However, in other examples, the state control means may comprise further elements and/or indeed the movable barrier may be removed.

In examples, the state control means may comprise a modifying liquid dispenser configured to dispense a modifying liquid into the trough. When the modifying liquid is dispensed into the liquid system, a property of the liquid system is modified. For example, the modifying liquid may be more acidic than the liquid system to thereby make the overall liquid system (i.e. the original liquid system plus the modifying liquid) more acidic than the original liquid system. For example, the modifying liquid may be more viscous than the original liquid system to thereby make the overall liquid system can be (i.e. the original liquid system plus the modifying liquid) more viscous than the original liquid system. It will be apparent to one of ordinary skill in the art that the modifying liquid dispenser and modifying liquid can be used to modify other properties of the liquid system such as for example: temperature; pH; lipid-type; ion or protein adsorption to the monolayer; solvent incorporation of the monolayer; isothermal compressibility; et cetera.

In examples, the state control means may comprise a heater disposed in or adjacent to the trough, wherein the heater is configured to change the temperature of liquid held in the trough.

In sum, the state control means 160 can be used to control the liquid system 100 to change the state of the liquid system. In this particular example, the state control means 160 can change the area of the liquid system 120 which causes a corresponding change in the lateral pressure of the liquid system 120. Changing the lateral pressure of the liquid system 120 causes a corresponding change in the isothermal compressibility of the liquid system

The isothermal compressibility of the liquid system (κ=−(1/A) (∂A/(∂π)_{T}) depends on the density of the lipid molecules at the surface of the liquid system. Changing the density of the lipid molecules at the surface changes the isothermal compressibility. Changing the isothermal compressibility of the system adjusts the dynamic range of the sensor comprising the liquid system.

The lipid monolayer is compressed from a state of maximum dilation to a state of maximum compression. In the state of maximum dilation the state of the phase of the lipid monolayer is liquid-expanded (LE). When the lipid monolayer is compressed from the state of maximum dilation to that of maximum compression, the allowed compression or compression headroom reduces monotonically as the compression increases. In the state of maximum compression the state of the phase of the lipid monolayer is liquid-condensed (LC). At some point during the compression of the lipid monolayer from the state of maximum dilation to the state of maximum compression the lipid monolayer undergoes an LE-LC phase transition.

As the lipid monolayer is compressed, the isothermal compressibility of the liquid system (an example susceptibility) and correspondingly the sensitivity of the liquid system increase up until the lipid monolayer begins an LE-LC phase transition). During the LE-LC phase transition of the lipid monolayer under compression, the isothermal compressibility and the sensitivity reach a maximum (an example of a stationary value of the compressibility). As the lipid monolayer is compressed further after the LE-LC phase transition the isothermal compressibility and the sensitivity decrease.

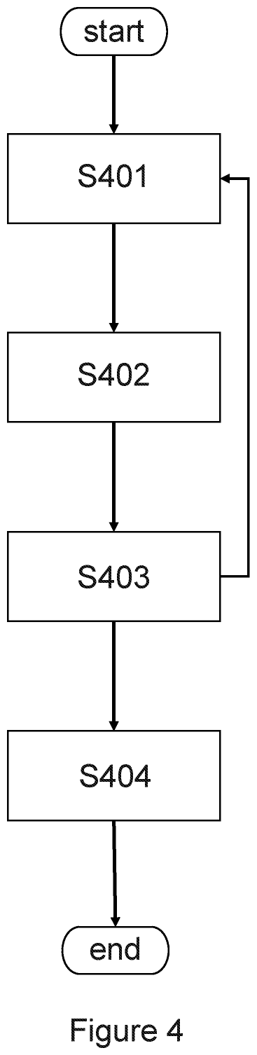

The minimum change in response that can be measured occurs near the inflexion point of the compression curve i.e. lateral pressure vs surface area isotherm. Therefore, dynamic range is a maximum near the phase transition. As shown in the FIG. 4B there is a maximum signal-to-noise ratio in the phase transition region.

The physical system (i.e. the sensor) described herein can be used for reservoir computing. For example, if an input signal is used to provide an input (e.g. a stimulus to the liquid system) and an output signal is derived from the surface wave data (e.g. one or more measured parameters of the surface wave measured by the detector) it can be seen that the sensor of the present disclosure provides a data operation which transforms this input signal into this output signal. The surface wave data may comprise a time series of samples obtained by measurements of the surface wave—for example this may comprise a wave form.

Equally, a reservoir computing unit may be used to apply a transformation to an input signal thereby to generate an output signal. The relationship between the output signal and the input signal corresponds to a transformation applied to the input signal by the reservoir computing unit. Embodiments of the disclosure therefore provide a reservoir computing unit comprising the sensor with a more general input 550 (e.g. instead of a contacting means, although it will be appreciated, in examples, a contacting means may be used as an input) which provides a stimulus to the liquid system based on a received input signal (e.g. a stimulus which encodes information carried by the input signal). The reservoir computing unit provides an output signal based on the wave data (i.e. one or more parameters of the one or more waves) arising from this stimulus. Two or more of these reservoir computing units can be connected together to form a network each of which may perform a different data operation. In some embodiments the input may be configured to apply stimuli corresponding to two or more input signals. These may be applied to the liquid separately from each other so that the corresponding wave data encodes information corresponding to the combination of those two signals.

It can thus be seen that in such units the output signal may depend on the input signal (or signals) in a non-linear way. A function associated with transforming the input signal (or signals) to the output signal may correspond to or represent a data operation performed by that reservoir computing unit.

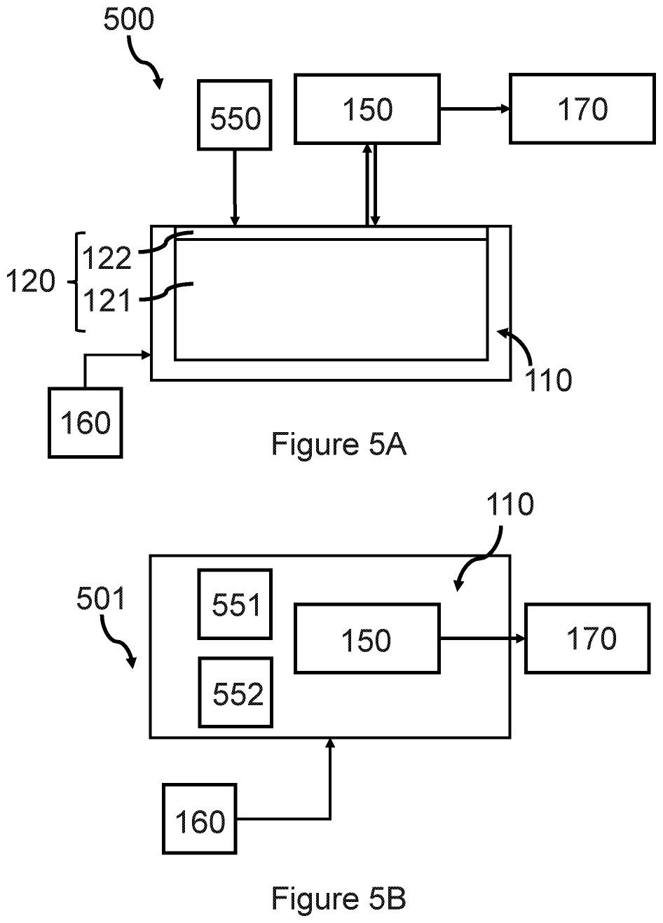

FIG. 5A illustrates a side view of a reservoir computing unit 500. The reservoir computing unit 500 is similar to the sensor 100 shown in FIG. 1, except that the contacting means of the sensor is replaced by an input 550 in the reservoir computing unit 500. For the avoidance of doubt the reservoir computing unit comprises: a trough 110 (i.e. a reservoir); a liquid system 120; an input 550; a detector 150; and a state control means 160. The detector 150 is commutatively coupled to a computer terminal 170.

The input 550 is configured to configured to provide a stimulus to the liquid system 120 to generate a response (e.g. a wave at the surface of the liquid system).

The input 550 is configured to receive an input signal. The input signal may be an electrical signal encoding data. The input 550 is configured to provide that input signal to a stimulator which provides a stimulus to the liquid system 120 held in the trough 110. The stimulus provided by the input 550 generates a response in the liquid system 120. The response may be one or more mechanical waves in and/or on the liquid, such mechanical waves may comprise a variety of wave modes including for example Lucassen waves.

The input 550 comprises a stimulator configured to provide the stimulus to liquid system held in the trough 110. The stimulator may be any stimulator described herein.

The stimulator may be configured to provide an electrical stimulus to the liquid. The stimulator may comprise a pair of electrodes and a voltage provider wherein the voltage provider is configured to provide a voltage between the electrodes (e.g. an alternating voltage). The electrodes may be arranged to provide a voltage difference in a direction parallel to the surface of the liquid (e.g. the stimulator may comprise an interdigitated transducer, IDT) or perpendicular to (e.g. through) the surface of the liquid.

The trough 110 holds the liquid system 120. The liquid system 120 is configured to receive a stimulus (i.e. from the input 550) based on an input signal to the input 550. A stimulus applied to the liquid generates a response in the form of mechanical waves as described above. The liquid system in FIG. 5A is shown as having a bulk liquid phase 121 and a thin film 122, however, it will be appreciated that the liquid system may comprise a liquid (i.e. and no thin film), for example, a liquid system consisting essentially of water.

The detector 150 may be an optical sensor as described herein. The detector 150 is configured to measure the response (e.g. the mechanical waves) generated by the stimulus. As described herein, the detector 150 measures a parameter of the response (i.e. a parameter of one or more mechanical waves e.g. the amplitude of the surface of the liquid as a time series). An output of the detector 150 is connected to computer terminal 170. The detector 150 provides an output signal to the computer terminal 170 via the output.

The output is configured to provide an output signal based on the parameter of the response (e.g. surface wave data such as the amplitude of the surface of the liquid as a time series). The output signal depends on the input signal in a non-linear way and a function associated with transforming the input signal to the output signal corresponds to or represents a data operation wherein said data operation is performed by the operation of the liquid system on the input signal.

The reservoir computing unit 500 is configured to provide a transformation of the input signal into the output signal. The transformation may depend on any of: the characteristics of the liquid system 120 in the trough 110 (e.g. whether the liquid system comprises a thin film and/or the properties of the thin film and/or the properties of the bulk liquid phase); the thermodynamic parameters of the liquid system and/or the thin film (e.g. temperature of the liquid); a specific depth of the liquid system.

To this end, the reservoir computing unit 500 is provided with the state control means 160. As described herein, the state control means 160 is configured to control the state of the liquid system 120 by controlling at least one of the thermodynamic parameters of the liquid system 120 (i.e. the state control means is configured to adjust one or more property of the liquid system). Therefore, using the state control means 160 the transformation performed by the unit 500 can be controlled by varying one or more of the properties of the liquid system using the state control means 160. In other words, the state control means 160 is configured to adjust a property of the liquid system to adjust the transformation provided by the liquid system. State control means are described in more detail herein.

In other words, the input based on the input signal generates a response in the liquid system and the output signal is based on the response. The output signal is based on a transformation of the input signal and the transformation itself is based on the response of the liquid system. The response of the liquid system depends on the thermodynamic state of the liquid system. The thermodynamic state of the liquid system is defined by thermodynamic properties of the liquid system.

In operation an input signal is provided to the input 550. The input signal encodes data or information e.g. in the form of a time-varying waveform. The stimulator of the input (not explicitly shown in FIG. 5A) provides a stimulus to the liquid system 120 indicative of the input signal from the input 550.

The stimulus induces a response in the liquid system 120. As set out above, the response may be one or more mechanical waves. The response is based on the input signal and the configuration of the reservoir computing unit 500. The response is measured by the detector 150 which may be an optical detector to obtain an indication of a parameter of surface waves (i.e. surface wave data) in the manner described herein.

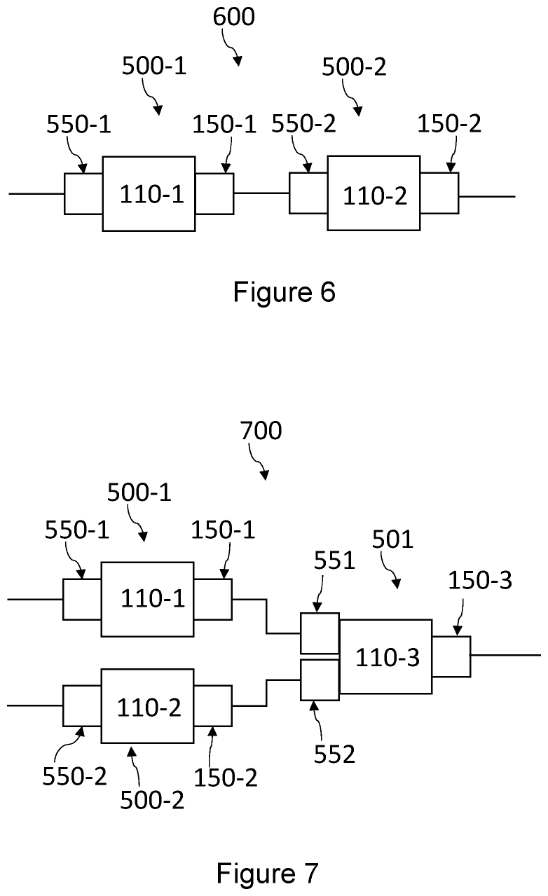

The output of the detector 150 provides an output signal indicative of the surface wave data. The output signal can be displayed on the computer terminal 170. The output signal from the detector 150 need not be provided to the computer terminal 170 and can instead be provided to any appropriate data processor. Examples of such data processors include general purpose computers, Application Specific Integrated Circuits (ASICs), Field Programmable Gate Arrays (FPGAs), Digital Signal Processors (DSPs) and any other logic circuit. Other examples include additional reservoir computing units such as those shown in FIG. 5A and FIG. 5B which may be connected together to form a network such as those described below with reference to FIGS. 6 & 7.

FIG. 5B is a simplified top-down schematic view of a reservoir computing unit 501 having two inputs 551 552. The reservoir computing unit 501 differs from the reservoir computing unit of FIG. 5A in that the unit 501 has two inputs, namely a first input 551 having a first stimulator and a second input 552 having a second stimulator. The unit 501 can be used to provide two stimuli based on the respective input signals to a liquid system to thereby generate a response in the liquid system. The response will be based on both input signals and therefore, the output signal which is based on the response will be based on both input signals. By applying two stimuli the two inputs may be combined by the unit 501.

FIG. 6 is a schematic view of a first reservoir computing system 600 comprising a plurality of reservoir computing units. In this example, a first unit 500-1 coupled in series with a second unit 500-2 i.e. the output of detector 150-1 of the first unit 500-1 is connected to the input 550-2 of the second unit 500-2.

Both, the first reservoir computing unit 500-1 shown in FIG. 6 and the second reservoir computing unit 500-2 shown in FIG. 6 may be provided by the reservoir computing units such as those described above with reference to FIG. 5A.

FIG. 6 shows reservoir computing units arranged in series to perform a series of transformations on an initial input signal (i.e. the input signal provided to a reservoir computing unit which is first in said series) to provide a final output signal (i.e. the output signal provided by a reservoir computing unit which is the final unit in said series) which is the result of the series of operations on the initial input signal.

FIG. 7 is a schematic view of a second reservoir computing system 700 comprising a plurality of reservoir computing units 500-1, 500-2, 501.

Both, the first reservoir computing unit 500-1 shown in FIG. 7 and the second reservoir computing unit 500-2 shown in FIG. 7 may be provided by the reservoir computing units such as those described above with reference to FIG. 5A. The third reservoir computing unit 501 shown in FIG. 7 may be provided by the reservoir computing unit such as that described above with reference to FIG. 5B.

Each of the reservoir computing units 500-1 and 500-2 comprise a state control means (not shown in the drawings) for adjusting one or more properties (e.g. thermodynamic parameters) of the respective liquid system. Each state control means may be operated to adjust a property of the liquid system to thereby adjust the transformation (i.e. on the input signal to thereby provide an output signal) provided by the liquid system.

FIG. 7 shows the first and second reservoir computing units 500-1 and 500-2 arranged in parallel to provide respective inputs to a third reservoir computing unit 501. A layered network is provided by connecting the output of the first detector 150-1 of the first reservoir computing unit 500-1 to a first input 551 of a third reservoir computing unit 501 and by connecting the output of the detector 150-2 of the second reservoir computing unit 500-2 to a second input 552 of the third reservoir computing unit 501. In this way, two parallel transformations are applied to respective inputs by the first and second units 500-1 & 500-2 then provided as inputs to a third reservoir computing unit 501 to provide an output from the detector 150-3 of the third unit 501 based on two separate inputs and three transformations (i.e. one transformation from each unit).

Each of the reservoir computing units 500-1, 500-2, and 501 comprise a state control means (not shown in the drawings) for adjusting one or more properties (e.g. thermodynamic parameters) of the respective liquid system. Each state control means may be operated to adjust a property of the liquid system to thereby adjust the transformation (i.e. on the input signal to thereby provide an output signal) provided by the liquid system.

It will be appreciated that a layered network may be provided by arranging any number of reservoir computing units in the manners depicted in FIG. 6 and FIG. 7.

The stimulator of inputs described herein may apply an electrical stimulus to the liquid system. However, other types of stimulus can be used, for example, the stimulator may be configured to provide a mechanical stimulus to the surface. For example, the stimulator may comprise an electromechanical element such as a piezoelectric transducer. The stimulator may be configured to provide a chemical stimulus to the surface e.g. by use of a contacting means as described herein. The mechanical and/or chemical stimulus may be provided in addition or as an alternative to the electrical stimuli described herein.

In examples wherein a reservoir computing system is provided each reservoir computing unit in said system may: have the same liquid in their respective reservoirs; or, at least one reservoir has a liquid in its respective reservoir which is different from the liquid in the other reservoirs; or, each reservoir has a unique liquid in its respective reservoir.

Liquids with thin films are described herein but embodiments of the present disclosure do not need a thin film. Instead embodiments may have a simple liquid provided in a reservoir and a stimulus can be applied on the surface of a simple liquid.

Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Any processors used in the computer system (and any of the activities and apparatus outlined herein) may be implemented with fixed logic such as assemblies of logic gates or programmable logic such as software and/or computer program instructions executed by a processor. The computer system may comprise a central processing unit (CPU) and associated memory, connected to a graphics processing unit (GPU) and its associated memory. Other kinds of programmable logic include programmable processors, programmable digital logic (e.g., a field programmable gate array (FPGA), a tensor processing unit (TPU), an erasable programmable read only memory (EPROM), an electrically erasable programmable read only memory (EEPROM), an application specific integrated circuit (ASIC), or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data store of the computer system (and any of the apparatus outlined herein).

Other examples and variations of the disclosure will be apparent to the skilled addressee in the context of the present disclosure.

The sensor may comprise a liquid system held in a trough (e.g. a Langmuir trough). A contacting means can be used to cause contact between a test substance and the surface of the liquid system, e.g. the external surface of the thin film. In addition to any mechanical wave generated by the contact, an electromechanical interaction between the substance and the lipid monolayer gives rise to additional waves such as Lucassen waves on the surface of the liquid system. A detector is used to measure a parameter of this surface wave. The measured parameter is used to generate an indication of the surface wave.

The indication is compared to stored indications (or difference measures which are based on indications) to determine a property of the test substance. The stored indications (or difference measures) may populate a database of stored indications wherein each entry of the database comprises a stored indication (or difference measure) and an associated property of the substance(s) used to generate said stored indication (or said difference measure).

The liquid system provides a transducer in the sense that a disturbance of one type may evoke a response of another (different) type. For example, the application of a mechanical disturbance to the surface may give rise to a corresponding electrical disturbance in response to the mechanical. The types of disturbance may relate to different types of energy for example: mechanical; electrical; magnetic; chemical.

The above types of energy may be coupled thermodynamically in any of the following ways: mechanical-electrical coupling (piezoelectric coupling or flexoelectric); mechanical-chemical coupling; mechanical-thermal coupling; mechanical-optical coupling.

The liquid system may have a surface which exhibits a first response and a second response to a stimulus wherein the first response is coupled to the second response e.g. by a thermodynamic and/or hydrodynamic coupling.

The surface may comprise a film with piezoelectric properties, the first response may be an electrical response and the first stimulus may be a mechanical stress and the second response may be a mechanical response and the second stimulus may be an electrical stress (explained in more detail below). The film may be thin, for example, a self-assembled single molecule thin film of phospholipid molecules at the air-water interface.

The liquid system may comprise a thin film carried on the bulk liquid phase wherein the thin film exhibits an electrical or chemical response to mechanical stress and vice versa, for example, piezoelectric properties such as those exhibited by liquid crystal. In other words, the thin film may: exhibit an electrical response to mechanical stress; and, exhibit a mechanical response to electrical stress. For example, the bulk liquid phase may comprise an aqueous phase and the thin film may comprise a lipid monolayer. Herein the term electrical stress refers to the stress on an object exerted by an electrical field.

The monolayer self assembles at the interface to maximize the system entropy as required by the second law of thermodynamics and is in the state of a complete or partial equilibrium. Therefore, there is an inherent thermodynamic coupling between the thermodynamic properties of the system as required by the Maxwell relations or the mixed derivatives at an entropy maximum. As a result, for example, there is a mechanical coupling in the thin film related to an electrical interaction of the molecules of the material which make up the film. Therefore, there is an inherent electromechanical coupling (resulting from the thermodynamics of the film) which exists in the film.

Perturbations to any one of the thermodynamic properties have a effect by virtue of the thermodynamic coupling as described here for a lipid thin film suspended in water: Shamit Shrivastava, Robin Cleveland, Matthias Schneider On measuring the acoustic state changes in lipid membranes using fluorescent probes Soft Matter, 2018,14, 9702-9712. Therefore, in the event that a test substance is applied to the thin film mechanical, electrical or chemical part of the perturbation may be emphasised at different time scales, the corresponding waves may travel at different speeds and arrive at different times at the secondary detector, and hence may be separated to infer a property of the test substance. In general terms in the event that a test substance is applied to the thin film there will be at least two components to the disturbance of the film, for example: one due to the mechanical effect, namely the physical disturbance resulting from the application of mechanical force; and, a second due to the perturbation of the electromechanical coupling wherein the nature of the second disturbance can be used to infer a property of the test substance.

In more detail, in the event that a test substance is applied to the thin film then the thin film will be perturbed chemically (e.g. chemical potential of the test substance with respect to insertion in the thin film, binding, or a local change in pH), thermally (release or absorption of heat due to exothermic or endothermic nature of interaction), electrically (hydrophobic or electrostatic interaction), mechanically (surface tension gradients, steric effects), and stereo-chemically (i.e. perturbation of the chirality of the system by adding a non-chiral and/or a molecule of opposite chirality to a monolayer of chiral molecules). These different interactions will perturb the film at different time scales setting up propagating surface waves in the thin film. The waves therefore allow mapping of timescales of interactions into wavelengths of the propagating wave as given by the dispersion relation for the surface waves. In other words, it allows mapping temporal features of a complex interaction into spatial features. Furthermore, the dispersion allows separation of these features in space making them easier to analyse. By measuring the properties of these waves physical and chemical properties of the test substance can be inferred.

Perturbations of the monolayer in response to an interaction with a test substance and the monolayer are indicative of the test substance, the lipid monolayer and the bulk liquid phase upon which the lipid monolayer sits. Put in other words, the surface wave resulting from said perturbations is indicative of the test substance, the lipid monolayer and the bulk liquid phase. The surface wave is characterised by parameters (e.g. amplitude, frequency, wavelength, wave speed).

Parameters of the surface wave may comprise any of: wavelength; frequency; wave speed; and amplitude. Amplitude herein may refer to: a change in surface density of particles at the surface of a liquid system (e.g. change in density of a lipid monolayer at the surface).

In other words, the surface wave is a physical mechanical wave. Parameters of a physical mechanical wave may be measured using, for example, any of: an optical detector (e.g. such as that described herein and/or that described in Shamit Shrivastava, Matthias F. Schneider Opto-Mechanical Coupling in Interfaces under Static and Propagative Conditions and Its Biological Implications and other papers cited herein); an output transducer (e.g. such as that described in WO2019234437A1)

The surface wave measured may also refer to a variation in any of: surface charge, dipole moment of the surface molecules, surface potential, surface ionization or protonation, lateral surface pressure, surface temperature. The variation of these system parameters may be referred to as a surface wave wherein the surface wave has parameters such as length; a frequency; a wave speed; and an amplitude. In this case amplitude refers to the magnitude of the surface charge, the magnitude of the dipole moment of the surface charge etc.

Parameters of these waves may be measured using, for example, any of: a temperature probe; an optical detector. For example, the optical detector may direct polarized light on the surface and detect polarized light reflected from the surface. Differences in polarization of the polarized light directed to the surface and of the polarized light which is reflected from the surface may be indicative of electrical phenomena on the surface (e.g. surface charge, dipole moment of the surface molecules, surface potential, surface ionization or protonation) and may be mapped to a change in a thermodynamic state of the surface.

Parameters of the surface wave may be coupled to one another. The coupling between parameters may be thermodynamic and as a result, one or multiple of these amplitudes can be measured simultaneously e.g. because the parameters are coupled. As set out above, the thermodynamic coupling may be an electro-mechanical coupling.

Examples described herein refer to a liquid system which comprises a bulk liquid phase carrying a lipid monolayer at the surface. Providing a lipid monolayer may be preferable as it functionalises the surface. That is, it provides an ordered surface the thermodynamic state of which is highly constrainable making it easy to perform a wide range of measurements (not just mechanical surface wave measurements but measurements of electrical phenomena at the surface e.g. dipole moment). However, the method and apparatus described herein are not constrained to a liquid system which comprises a bulk liquid phase carrying a lipid monolayer at the surface. For example, the methods and apparatus described herein may be equally applicable to a liquid system consisting essentially of water.

A property of a test substance may be determined based on parameters of a surface wave generated by the test substance because the nature of the interaction between the test substance and the surface of the liquid system. The interaction is a complex phenomenon because of the involvement of so many physical and chemical variables but is highly reproducible. An account of the interaction is set out below.

When the test substance is brought close to or in contact with a surface of a liquid system there is a local change of enthalpy at the surface (e.g. sometimes referred to as an local injection of enthalpy). The local change in enthalpy in the surface is coupled to the amplitude of the lateral surface pressure wave by the following equation:

$$Δ h - Δπ ( {a}_{0} + a ) = 0$$

### Wherein:

Δh is the change in enthalpy of the surface;
Δπ is the change of lateral surface pressure of the surface;
a₀ is equivalent specific area for the lipid monolayer before the wave arrives
a is equivalent specific area of the lipid monolayer across the wavefront

The above equation is obtained using one dimensional detonation theory as described here: Shamit Shrivastava Shock and detonation waves at an interface and the collision of action potentials Prog Biophys Mol Biol 2021 July; 162:111-121. doi: 10.1016/j.pbiomolbio.2020.12.002. Epub 2021 Jan. 28.

The amount of enthalpy released when a chemical is added to the surface of the liquid system (referred to sometimes as the interface) is approximately given by its chemical potential with respect to the interface:

$${μ}_{i} \approx {( \frac{δ h}{δ {N}_{i}} )}_{S , π , {N}_{j \neq i}}$$

### Wherein:

μᵢ is the chemical potential of the Nᵢ molecules of a species i interacting with the surface;
Nᵢ is the number of molecules of a species i which interact with the surface;
h is the enthalpy of the surface;
π is the lateral surface pressure;
S is the entropy of the surface.

There are many variables involved in the interaction thereby making it very complex to forward model. For example, the enthalpy is not released at an instant but is released over by a variable amount over a large time period and also, the chemical potential is a result of numerous kinds of forces and interactions each having different timescales.

Furthermore, for example, different lipid films have different susceptibilities for absorbing energy from the test substance at different timescales (e.g. a peak in absorption spectrum may exist that depends on the lipid and its thermodynamic state as shown here; D. B. Tata and F. Dunn Interaction of ultrasound and model membrane systems: analyses and predictions J. Phys. Chem. 1992, 96, 8, 3548-3555 Apr. 1, 1992). The above description also discounts dissipation that is unavoidable and is also distributed in time as given by the various viscosities of different components in the interaction. Finally the energy transferred from the test substance to the surface of the liquid system may partitioned between different surface wave modes (e.g. a first fraction of the energy generates Lucassen wave and a second fraction of the energy generates Rayleigh waves etc.).

It is possible to use a liquid system consists essentially of water because the fundamentally mechanism relies determining a thermodynamic state of the surface of the liquid system (and determining changes thereto), for example, based on the electric potential at the surface.

In examples, wherein the liquid system consists essentially of water, the surface of the liquid system comprises an air-water interface. The air-water interface has a surface potential which can be measured (see e.g. K. Leung, J. Phys. Chem. Lett. 2010, 1, 2, 496-499 Publication date 28 Dec. 2009) and used to excite capillary waves electrically (see e.g. L. Cantu et al. An interferometric technique to study capillary waves, Advances in Colloid and Interface Science, Volume 247, 2017, Pages 23-32).

Put simply, energy is released from the interaction between the test substance and the surface of the liquid system and this energy has to dissipate). A first fraction of the energy released may diffuse without generating a measurable wave but a second fraction of the energy released may generate a surface wave which is measurable. Of the second fraction of the energy which generates a surface wave (referred to as the propagating component), this energy is further divided into further fractions such as: a third fraction which will dissipate into the bulk liquid phase as usual sound waves; a fourth fraction which will generate a first surface wave e.g. Lucassen waves; and, a fifth fraction which will generate a second surface wave (e.g. a Rayleigh waves) etc. The partition of the energy into the above components will be determined by various rules dependent on the compressibility and viscosities of the two media (e.g. the air and water).

In examples wherein the liquid system consists of a bulk liquid phase and does not comprise a thin film (e.g. a liquid system consisting essentially of water) the interface (surface of the liquid system forming the air-liquid interface) is quite incompressible and, therefore, less energy may partition into bulk liquid phase as typical sound waves in comparison to the amount of energy which generates surface waves (e.g. capillary modes).

The liquid system need not comprise any thin film. For example, the methods described herein may be performed with a thin film such as a lipid monolayer or without a thin film at all (e.g. with just a bulk liquid phase). The methods described herein may be performed using an analytical apparatus such as that illustrated in FIGS. 1A to 1C or by utilising or retrofitting existing apparatus such as a Langmuir trough.

The term laminar flow herein refers to a flow of a liquid system wherein the Reynold number, Re, of the liquid system (which is proportional to the volumetric flow rate of the liquid system) is sufficiently low in order to prevent turbulent flow phenomena from occurring in the liquid system (e.g. vortex shedding etc.). For example, a sufficiently low volumetric flow of the liquid system may be provided to thereby provide a laminar flow of the liquid system. For example, the volumetric flow of the liquid system may be provided which provides a Reynolds number less than or equal to 2000, or more preferably less than or equal to 1800.

Parameters of the liquid system which may be controlled to provide a laminar flow may include any of: the dimensions of the trough which holds the liquid system (e.g. depth; length; width); the volumetric flow rate of the liquid system; the speed of the fluid (e.g. mean speed); the dynamic viscosity of the liquid system μ; v the kinematic viscosity of the fluid, the density of the fluid ρ.

Herein the term aqueous phase refers to any liquid comprising water.

Herein the term lipid monolayer may refer to a single layer of lipid molecules arranged on a surface of an aqueous phase wherein a hydrophilic end of each of the lipid molecules is disposed in the aqueous phase to thereby provide a layer of lipid molecules orientated in a like manner.

Herein the term lipid monolayer may refer to a single layer of lipid molecules arranged on a surface of an aqueous phase wherein a hydrophilic end of each of the lipid molecules is disposed in the aqueous phase to thereby provide a layer of lipid molecules orientated in a like manner.

The chemical constituents (e.g. the species) and/or properties of the lipid monolayer and the bulk liquid phase may be known and used to infer the chemical constituents and/or properties of the test substance based on parameters of the wave.

In examples the amplitude of a surface wave may have a direct effect on the lateral surface pressure at a given point on the surface e.g. as the surface wave propagates across the surface the lateral surface pressure at a given point varies in response to changes in amplitude at that point on the surface.

A flowing liquid system may be a free stream. A free stream refers to a liquid which does not need to be held in a container. A free stream may be a laminar stream that comes out of a tap and measurements can be made on the surface of said from stream.

In examples, the liquid system comprises a spherical blob which floats in zero gravity or a microgravity environment.

Phase transitions in lipids (e.g. lipid monolayers) can be modelled in the same manner as phase transitions in Van de Waals gases as set out in Mussel, M., Schneider, M. F. Similarities between action potentials and acoustic pulses in a van der Waals fluid. Sci Rep 9, 2467 (2019).

Thermodynamic susceptibilities may be dependent on one another i.e. a second thermodynamic susceptibility may be determined approximately based on a first thermodynamic susceptibility, and also, for example, other parameters of the system. For example, the isothermal compressibility of a combined system may be determined based on the adiabatic compressibility. Put in other words, the ability and magnitude to which a liquid system or a combined system may generate sound waves (i.e. the adiabatic compressibility) may be determined based on the isothermal compressibility.

The response of a generic liquid system is described in detail in Thomas Heimburg. “Linear nonequilibrium thermodynamics of reversible periodic processes and chemical oscillations Phys. Chem. Chem. Phys., 2017,19, 17331-17341 (See e.g. FIG. 1). As described therein, when plotted in state space the response of a liquid system has both a magnitude and a phase both of which change with time.

Thermodynamic susceptibilities can be estimated using the Taylor expansion of a thermodynamic potential. The present example illustrates obtaining a susceptibilities of the liquid system by Taylor expansion of the entropy, S. Near an equilibrium the maths is simplified and expanding to second order terms we get (as explained in Shrivastava et. al. Soft Matter, 2018,14, 9702-9712).

Examples of how to provide a liquid system suitable for use in the sensor are set out in Shamit Shrivastava, Kevin Heeyong Kang, and Matthias F. Schneider Phys. Rev. E 91, 012715.

In some examples, a perturbation can be provided without contacting the test substance with the surface of the liquid system. For example, the perturbation may be an interaction between the liquid system and a test substance can be at a distance e.g. via an electromagnetic interaction between the surface of the liquid system and the test substance. In response to said perturbation, a mechanical response is induced in the liquid system e.g. surface wave modes indicative of the charge of the test substance.

Liquid systems such as liquid system 120 of the sensor 100 have a minimum measurable response. This is evidenced in, for example, part 4 of Shrivastava S, Schneider M F. 2014 Evidence for two-dimensional solitary sound waves in a lipid controlled interface and its implications for biological signalling. J. R. Soc. Interface 11:20140098.

When the perturbation is a sound wave (e.g. a Lucassen wave) in the liquid system, the coupling between the perturbation and the response may be determined by the adiabatic compressibility of the combined system i.e. compressibility of the combined system at a constant heat and mass.

When the perturbation is a slow compression in the liquid system, the coupling between the perturbation and the response may be determined by the isothermal compressibility of the combined system i.e. compressibility of the combined system at a constant temperature.

In examples, in use, the trough may be disposed at an angle (e.g. obliquely) to a horizontal surface (e.g. a tabletop) thereby defining an upper end of the trough and a lower end of the trough to thereby provide a flowing liquid system wherein the liquid system flows towards the bottom end of the trough.

1. A method for controlling a sensor for determining a property of a test substance, the sensor having a sensitivity and dynamic range, the sensor comprising:
a liquid system comprising:
a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system, the sensor configured to:
contact the surface of the liquid system with the test substance thereby to generate a surface wave on the liquid system; and,
determine the property of the test substance based on parameters of the surface wave;
wherein the method for controlling the sensor comprises:
controlling the sensitivity by changing a thermodynamic parameter of the liquid system.

2. The method of claim 1, comprising:
obtaining an indication of at least one thermodynamic parameter of the liquid system.

3. The method of claim 2, comprising:
controlling the thermodynamic parameter of the liquid system based on the indication of the same thermodynamic parameter of the liquid system.

4. The method of claim 2, comprising:
controlling the thermodynamic parameter of the liquid system based on the indication of another thermodynamic parameter of the liquid system.

5. The method of any of the preceding claims, wherein:
controlling the sensitivity by changing a thermodynamic parameter of the liquid system comprises controlling the lateral surface pressure of the liquid system.

6. The method of claim 5, wherein:
the lateral surface pressure of the liquid system is changed by changing the surface area of the liquid system.

7. A method for controlling a sensor for determining a property of a test substance, the sensor having a sensitivity and dynamic range, the sensor comprising:
a liquid system comprising:
a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system, the sensor configured to:
contact the surface of the liquid system with the test substance thereby to generate a surface wave on the liquid system; and,
determine the property of the test substance based on parameters of the surface wave;
wherein the method for controlling the sensor comprises:
controlling the dynamic range by changing a thermodynamic parameter of the liquid system.

8. The method of any claim 7, comprising:
obtaining an indication of at least one thermodynamic parameter of the liquid system.

9. The method of claim 8, comprising:
controlling the thermodynamic parameter of the liquid system based on the indication of the same thermodynamic parameter of the liquid system.

10. The method of claim 8, comprising:
controlling the thermodynamic parameter of the liquid system based on the indication of another thermodynamic parameter of the liquid system.

11. The method of any of claims 7 to 10, wherein:
controlling the sensitivity by changing a thermodynamic parameter of the liquid system comprises controlling the lateral surface pressure of the liquid system.

12. The method of claim 11, wherein:
the lateral surface pressure of the liquid system is changed by changing the surface area of the liquid system.

13. The method of any of the preceding claims wherein:
the thin film is a monolayer.

14. The method of any of the preceding claims wherein:
the bulk liquid phase comprises an aqueous solution.

15. The method of any of the preceding claims, wherein:
the liquid system comprises film material dispersed in the bulk liquid phase.

16. A sensor for determining a property of a test substance, the sensor having a sensitivity and dynamic range, the sensor comprising:
a trough for holding a liquid system;
a liquid system comprising:
a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system, the sensor configured to:
contact the surface of the liquid system with the test substance thereby to generate a surface wave on the liquid system; and,
determine the property of the test substance based on parameters of the surface wave;
the sensor comprising a state control means configured to control the sensitivity by changing a thermodynamic parameter of the liquid system.

17. The sensor of claim 16, further comprising:
a detector configured to detect one or more parameters of a surface wave generated in the surface of the liquid system.

18. The sensor of any of claims 16 to 17, further comprising:
a contacting means configured to contact the test substance to the surface of the liquid system.

19. The sensor of any of claims 16 to 18, wherein the state control means is configured to change the lateral surface pressure of the liquid system.

20. The sensor of claim 19, wherein the state control means is configured to change the lateral surface pressure of the liquid system by changing the surface area of the liquid system.

21. The sensor of any of claims 16 to 20, wherein the state control means is configured to change the temperature of the liquid system.

22. The sensor of any of claims 16 to 21, wherein the sensor is controllable using the method of any of claims 1 to 15.

23. A method for adjusting the response of a liquid system to a stimulus, the method comprising:
providing a stimulus to a surface of a liquid system, based on an input signal, to generate a response in the liquid system wherein the response comprises one or more waves in the liquid system;
detecting a parameter of the one or more waves and providing an output signal based on the parameter wherein: the output signal is related to the input signal by a transformation of the input signal provided by the liquid system;
adjusting one or more properties of the liquid system to adjust the transformation provided by the liquid system.

24. The method of claim 23, wherein:
the liquid system comprises a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system.

25. The method of any of claims 23 to 24, wherein the stimulus comprises an electrical stimulus applied to the liquid system by one or more electrodes.

26. The method of any of claims 23 to 25, comprising:
adjusting one or more properties of the liquid system thereby to adjust a sensitivity, for example wherein the transformation depends on the sensitivity.

27. The method of claim 26, wherein:
sensitivity of the sensor may be proportional to a susceptibility of the lipid monolayer, for example a thermodynamic susceptibility.

28. The method of any of claims 23 to 27, comprising:
adjusting one or more properties of the liquid system to adjust a dynamic range, for example a dynamic range of the transformation.

29. The method of claim 28, wherein:
the dynamic range of the reservoir computing unit is a range of response values which can be distinguished in a given thermodynamic state of the liquid system.

30. A method of controlling a reservoir computing unit to control a data transformation applied to an input signal by the reservoir computing unit, the reservoir computing unit comprising a liquid system and the method comprising adjusting the response of the liquid system according to the method of any of claims 23 to 29.

31. A reservoir computing system or reservoir computing unit configured to perform the method of claim 30.

32. A reservoir computing unit comprising:
an input for receiving an input signal,
a trough for holding a liquid system,
a detector configured to:
measure the response of a liquid held in the trough to a stimulus based on the input signal; and,
output an output signal based on the parameter wherein: the output signal is based on a transformation of the input signal; and, said transformation is provided by the liquid system;
a state control means configured to adjust one or more properties of the liquid system thereby to adjust the transformation provided by the liquid system.

33. The reservoir computing unit of claim 32, wherein:
the liquid system comprises a bulk liquid phase carrying a thin film on the surface of the bulk liquid phase; wherein the thin film comprises a film material and wherein the thin film exhibits an electrical response to mechanical stress and vice versa wherein said response depends on the thermodynamic state of the liquid system.

34. The reservoir computing unit of any of claims 32 to 33, comprising one or more electrodes configured to provide the stimulus to the liquid system wherein the stimulus comprises an electrical stimulus.

35. The reservoir computing unit of any of claims 32 to 34, wherein:
the state control means is configured to adjust one or more properties of the liquid system thereby to adjust a sensitivity, for example wherein the transformation depends on the sensitivity.

36. The reservoir computing unit of claim 35, wherein:
sensitivity of the sensor may be proportional to a susceptibility of the lipid monolayer, for example a thermodynamic susceptibility.

37. The reservoir computing unit of any of claims 32 to 36, wherein:
the state control means is configured to adjust one or more properties of the liquid system to adjust a dynamic range, for example a dynamic range of the transformation.

38. The reservoir computing unit of claim 37, wherein:
the dynamic range of the reservoir computing unit is a range of response values which can be distinguished in a given thermodynamic state of the liquid system.
